(19) United States
(12) Patent Application Publication
(10) Pub. No.: US 2006/0104472 A1
(43) Pub. Date: May 18, 2006

(54) Voice coil device and speaker device using the voice coil device

(75) Inventors: Yasuhisa Abe, Tendo-shi (JP); Yoshimi Kudo, Tendo-shi (JP)

Correspondence Address: NIXON & VANDERHYE, PC, 901 NORTH GLEBE ROAD, 11TH FLOOR, ARLINGTON, VA, 22203, US

(73) Assignees: Pioneer Corporation, Tokyo (JP); Tohoku Pioneer Corporation, Yamagata (JP)

(21) Appl. No.: 11/274,277

(22) Filed: Nov. 16, 2005

(30) Foreign Application Priority Data
Nov. 18, 2004 (JP) 2004-334526
Nov. 22, 2004 (JP) 2004-337402
Nov. 22, 2004 (JP) 2004-337406

(51) Int. Cl. H04R 9/06

(52) U.S. Cl. 381/409; 381/400; 381/410

(57) ABSTRACT

A speaker device includes a vibration system having a frame, first and second voice coils, a voice coil bobbin, a diaphragm and a magnetic circuit holder, and a magnetic circuit system having a yoke, a magnet and first and second plates. The first and second voice coils are wound around the voice coil bobbin with a constant space. The diaphragm has a step portion having an upper surface ensuring flatness at an inner peripheral portion (neck) thereof. An inner peripheral edge portion of the diaphragm is fixed to the voice coil bobbin. The first plate, the magnet and the second plate are fixed onto a pole portion of the frame in an upward order, respectively. The annular yoke is mounted onto a predetermined position of the magnetic circuit holder formed into a mushroom shape, and the magnetic circuit holder is fixed onto the second plate via a bolt. Thereby, the first and second magnetic gaps are formed in the vicinity of the first and second voice coils, respectively.

### BACKGROUND OF THE INVENTION

1. Field of the Invention

The present invention relates to structures of a voice coil device and a magnetic circuit for a speaker device, and a mounting method of the speaker device.

2. Description of Related Art

Conventionally, there is known a speaker device including a vibration system having a diaphragm and a voice coil device having a voice coil bobbin, a voice coil wound around the voice coil bobbin and a wound member (e.g., a tape or a belt paper) attached to the voice coil bobbin, and a magnetic circuit having a yoke, a magnet and a plate. The magnetic circuit is arranged on a rear side of the diaphragm.

As the voice coil device of this kind, there is known a voice coil bobbin having a bobbin around which the voice coil is wound and a reinforcement tape which is attached to the bobbin at an upper portion of the voice coil and on which a positioning portion for attaching a lead wire is formed (see Japanese Patent Application Laid-open under No. 7-288894, for example). According to this document, a cut-out portion constituting the positioning portion of the leadwire is formed on an upper side of the reinforcement tape, and the voice coil and the lead wire are soldered at the position of the cut-out portion.

In addition, there is known a voice coil bobbin having a copper piece onto which a pressing tape is attached. This technique is disclosed in Japanese Patent Application Laid-open under No. 2003-284188. The pressing tape is wound around the voice coil bobbin so that a hole provided on the pressing tape is positioned on the copper piece. The lead wire of the voice coil under the pressing tape and an external lead wire are soldered at the position of the hole.

As described above, in a case of the speaker device employing the voice coil bobbin onto which the wound member is attached, the wound member is attached to the voice coil bobbin to cover a part of the voice coil, and the lead wire constituting the voice coil is drawn outward at an end portion of the tape. Therefore, there is a problem that in some drawing states of the lead wire, tinsel stress and bending stress repeatedly operate on a drawn portion from the wound member of the lead wire in accordance with the driving of the speaker device, and hence the lead wire is cut at a bent and folded portion thereof. Particularly, when the lead wire is bent and folded at an acute angle at the drawn portion from the wound member, the lead wire is easily cut at the portion.

Conventionally, there is known an external-magnet type speaker device including a vibration system having a cone-shape diaphragm, a voice coil bobbin, a voice coil and a frame, and a magnetic circuit having a yoke, a magnet and a plate. As a shape of the cone-shape diaphragm, there are known a so-called straight shape having a straight cross-section and a paracurved shape having a curved cross-section like a bow.

As an example of such a speaker device, there is known a speaker device in which the magnetic circuit is arranged on a front side (sound output side) of the diaphragm (see Japanese Patent Applications Laid-open under No. 2003-299185 and No. 9-18983 and Japanese Patent No. 3412291, for example). In those speaker devices (i.e., a speaker device of “a front magnetic circuit system”), one magnetic gap is formed between the voice coil bobbin and the magnetic circuit, and one voice coil is wound around the voice coil bobbin corresponding to the one magnetic gap (i.e., “1-magnetic gap and 1-voice coil system”).

In the above-mentioned speaker device of the front magnetic circuit system, the 1-magnetic gap and 1-voice coil system is employed. Therefore, in such a speaker device, at the time of excessive input to the voice coil, the voice coil bobbin and the voice coil vibrate with large magnitude. Thereby, the voice coil bobbin or the voice coil problematically collides with the frame and the magnetic circuit.

In addition, in the speaker device of the front magnetic circuit system using the cone-shape diaphragm formed into the above-mentioned straight shape, there is a problem that high-frequency-band limit frequency Fh is generally high and hence an unnecessary high-frequency component (peak) occurs thereabout. For the purpose of solving such a problem, the shape of the diaphragm has to be improved. For example, if the cross-section of the diaphragm is formed into the paracurved shape, the peak hardly occurs around the high-frequency-band limit frequency Fh, and a flat sound pressure characteristic can be obtained. However, in such a speaker device, since the magnetic circuit is provided on the front side of the diaphragm, the diaphragm cannot be curved to project to the sound output side without a restriction. Namely, when the cone-shape diaphragm formed into the paracurved shape is used for such a speaker device, it is problematic that since an inner peripheral portion (neck) of the diaphragm is curved to project to the side of the magnetic circuit, a space between the diaphragm and the magnetic circuit becomes small and hence a magnitude margin (magnitude width) of vibration of the diaphragm becomes small.

Moreover, in the speaker device according to Japanese Patent No. 3412291, a dustproof cushion is mounted onto the neck of the diaphragm in order to enhance a dustproof effect. However, in such a speaker device, when the dustproof cushion is mounted onto the neck (inclined surface) of the diaphragm by an adhesive, the adhesive problematically flows onto the neck side of the diaphragm at the time of mounting the dustproof cushion.

Conventionally, an on-vehicle speaker device includes a vibration system having a diaphragm, a voice coil bobbin, a voice coil and a frame, and a magnetic circuit having a yoke, a magnet and a plate, for example, and the magnetic circuit is arranged on a rear side of the diaphragm.

Such an on-vehicle speaker device is mounted on a mounting portion of a door and an inner panel. For example, in the speaker device, a part of the frame positioned on the front side (sound output side) is mounted onto the mounting portion of the vehicle via a fixing member.

An on-vehicle speaker device having a mounting manner of this kind is disclosed in Japanese Patent Application Laid-open under No. 2004-15566. In the speaker device according to this document, by adding a heavy and thin weight to a rear side thereof, vibration occurring by reaction force of the diaphragm is suppressed so that sound quality is improved. In addition, there is known a speaker system in which a diaphragm vibrating portion including a magnetic field path and a voice coil is arranged on a rear surface or a front surface of an acoustic wave emitting direction (see Japanese Patent Applications Laid-open under No. 61-111092). The speaker device according to the document is mounted on a cabinet via the frame.

Further, there is known a conductive speaker device in which two magnetic gaps are provided on opposite surfaces of the magnetic circuit and thus a voice coil bonded to the cone-shape diaphragm and a tweeter voice coil bonded to a tweeter diaphragm are arranged on each of the magnetic gaps, respectively (see Japanese Patent Applications Laid-open under No. 63-120595).

In the above-mentioned on-vehicle speaker device, the magnetic circuit is arranged on the rear side, and a part of the frame positioned on the front side (sound output side) is mounted on the mounting portion in the vehicle. Therefore, gravity of the on-vehicle speaker device is positioned in the vicinity of the rear side. Hence, at the time of the driving of the on-vehicle speaker device, the vibration by the diaphragm is transmitted to the mounting portion of the vehicle via the frame, and thus an abnormal sound problematically occurs from the mounted portion.

### SUMMARY OF THE INVENTION

The present invention has been achieved in order to solve the above problems. It is an object of this invention to provide a voice coil device and a speaker device using the voice coil device capable of preventing a lead wire of a voice coil from cutting at the time of driving of the voice coil device.

It is another object of this invention to provide a speaker device capable of preventing the voice coil bobbin from colliding with a magnetic circuit and suppressing an unnecessary high-frequency component (peak) around high-frequency-band limit frequency Fh. In addition, it is still another object of this invention to provide a speaker device capable of preventing an adhesive from flowing to a neck side of the diaphragm at the time of mounting a buffer member (including a dustproof function) onto a diaphragm.

Further, it is still another object of this invention to improve a weight balance by arranging the magnetic circuit on a sound output side (front side) of the diaphragm, thereby to suppress transmission of unnecessary vibration to a speaker mounting portion of a vehicle and occurrence of an abnormal sound from the speaker mounting portion and to make a protruding dimension of the speaker device from the speaker mounting portion to the sound output side as small as possible.

According to one aspect of the present invention, there is provided a voice coil device including: a voice coil bobbin; a voice coil which has a lead wire and is wound around the voice coil bobbin; and a wound member which is divided into at least two parts and is attached to the voice coil bobbin to cover a part of the lead wire, wherein the lead wire is gently curved and bent into a curve shape between the voice coil bobbin and the wound member to be drawn out from a border of the divided wound member.

The above-mentioned voice coil device includes the voice coil bobbin formed into a cylindrical shape, the voice coil which has the lead wire and is wound around the voice coil bobbin, and wound member which is divided into at least two parts and is attached to the voice coil bobbin, for example. As the wound member, a member such as durable band paper capable of being freely bent, one surface of which the adhesive is applied to, is preferred, for example. The wound member is divided into at least two parts, preferably, which are not overlapped in the axis direction of the voice coil bobbin, and is attached to the voice coil bobbin to cover the part of the lead wire. Therefore, the border for drawing out the lead wire is formed between the two parts of the wound member.

If the voice coil device having such a structure is applied to the speaker device, at the time of the driving of the speaker device, the voice coil device vibrates in the axis direction. Particularly, in the voice coil device, since the bent portion of the lead wire is gently curved and bent into the curved shape, at the time of the driving the voice coil device, stress cutting the lead wire hardly operates on the bent portion, and the stress never concentrates on the bent portion. Thus, the cutting of the lead wire can be prevented.

In the above voice coil device, the bent portion of the lead wire has preferably an acute angle. By bending the lead wire at the acute angle, a possibility of cutting the lead wire can be decreased.

In a manner of the above voice coil device, the wound member may have a first wound member and a second wound member. A part of the lead wire may be covered with the first wound member, and the bent portion of the lead wire may be covered with the second wound member. In this manner, the part of the lead wire is covered with the first wound member, and the bent portion of the lead wire is covered with the second wound member. Thus, at the time of the driving of the voice coil, it can be prevented that the stress concentrates on the bent portion of the lead wire.

In a preferred example of the above voice coil device, the lead wire may be bent in a direction from the second wound member to the first wound member between the voice coil bobbin and the second wound member to be drawn out in an outer circumferential direction of the first wound member. Thereby, it can be suppressed that the lead wire is rubbed with the end portion of the second wound member at the border between the first and second wound members, and the possibility of cutting the lead wire can be decreased.

In another manner of the above voice coil device, the wound member may fix the lead wire to the voice coil bobbin in a manner that the lead wire does not move. Therefore, it can be prevented that by the movement of the voice coil device, the lead wire moves to be rubbed with the end portion of the wound member and hence the lead wire is cut by the rubbing.

According to another aspect of the present invention, there is provided a speaker device including: a magnetic circuit; and a vibration system including a diaphragm and the above voice coil device, wherein the lead wire is gently curved and bent into a curve shape between the voice coil bobbin and the wound member to be drawn out from a border of the divided wound member, and wherein the magnetic circuit is arranged on a sound output side of the diaphragm. Namely, the magnetic circuit is arranged on the sound output side (front side) of the diaphragm. The above-mentioned voice coil device is applicable to the speaker device of the front magnetic circuit system. In the speaker device of the front magnetic circuit system, since the lead wire of the voice coil is drawn out in the direction of the magnetic circuit positioned on the sound output side of the voice coil device, the drawn-out portion of the lead wire from the voice coil device easily becomes the acute angle, and the cutting of the lead wire easily occurs at the portion. In this point, in the speaker device of the present invention, since the lead wire of the voice coil is gently curved to be fixed by the wound member, the cutting of the lead wire can be suppressed.

In a manner, the above speaker device may further include a tinsel cord which is electrically connected to a signal supplying circuit of an amplifier, wherein one end of the tinsel cord is drawn on the sound output side of the diaphragm, and the lead wire drawn out of the wound member is electrically connected to the one side of the tinsel cord. Thereby, the signal and electric power can be supplied to the voice coil from the signal supplying circuit of the amplifier via the tinsel cord and the drawn-out portion of the lead wire.

According to still another aspect of the present invention, there is provided a speaker device including a vibration system including a diaphragm and a magnetic circuit, wherein the magnetic circuit is arranged on a sound output side of the diaphragm, wherein the magnetic circuit includes plural magnetic gaps, and the vibration system includes a voice coil bobbin and plural voice coils wound around the voice coil bobbin, and wherein each of the correspondent voice coils is arranged in each of the magnetic gaps, respectively.

In a preferred example, the magnetic circuit may include a first plate, a magnet arranged on the first plate, both surfaces of which are magnetized, a second plate arranged on the magnet, and a yoke opposite to each outer peripheral wall of the first plate, the magnet and the second plate with a constant space. In addition, the plural magnetic gaps may include a first magnetic gap and a second magnetic gap, and the first magnetic gap may be positioned between the first plate and the yoke and the second magnetic gap may be positioned between the second plate and the yoke. Moreover, the plural voice coils may include a first voice coil and a second voice coil, and the first voice coil may be arranged in the first magnetic gap and the second voice coil may be arranged in the second magnetic gap. Namely, the speaker device includes the magnetic circuit of a 2-magnetic gaps and 2-voice coils system. In addition, it is preferable that the magnetic fields formed in the first and second magnetic gaps are relatively set in the opposite directions.

In another preferred example, the speaker device may further include a signal supplying circuit which supplies an electric signal having same level and phase to the first voice coil and the second voice coil, wherein the first voice coil and the second voice coil have a same effective line length and are relatively wound in opposite directions. In this case, in the speaker device, when the electric signal having the same level and phase is inputted to the first and second voice coils from the signal supplying circuit, the voice coil bobbin vibrates and thus the acoustic wave is emitted from the front side (sound output side) of the diaphragm. Instead of this example, the speaker device may further include a signal supplying circuit which supplies an electric signal having a same level and an opposite phase to the first voice coil and the second voice coil, wherein the first voice coil and the second voice coil have a same effective line length and are relatively wound in a same direction. In this case, in the speaker device, when the electric signal having the same level and the opposite phase is inputted to the first and second voice coils from the signal supplying circuit, the voice coil bobbin vibrates and thus the acoustic wave is emitted from the front side (sound output side) of the diaphragm.

Particularly, the speaker device employs the 2-magnetic gaps and 2-voice coils system. Therefore, when the excessive input signal is inputted to the first and second voice coils due to a cause of some sort and hence the voice coil bobbin moves to the sound output side with the large magnitude, the first voice coil is positioned in the second magnetic gap (case 1). Meanwhile, when the excessive input signal is inputted to the first and second voice coils and hence the voice coil bobbin moves on the side opposite to the sound output side with the large magnitude, the second voice coil is positioned in the first magnetic gap (case 2).

In the case 1, the first voice coil is affected by the magnetic field of the second magnetic gap, and force (damping force) for movement to the side opposite to the sound output side operates on the first voice coil. Namely, in this case, since the first voice coil moves to the side opposite to the sound output side, it is restricted that the voice coil bobbin moves to the sound output side with the large magnitude.

On the other hand, in the case 2, the second voice coil is affected by the magnetic field of the first magnetic gap, and the force (damping force) for the movement to the sound output side operates on the second voice coil. Namely, in this case, since the second voice coil moves to the sound output side, it is restricted that the voice coil bobbin moves to the side opposite to the sound output side with the large magnitude. Thereby, it can be suppressed that the voice coil bobbin collides with the opposite magnetic circuit and frame.

In a manner of the above speaker device, the vibration system may include a frame having a projecting portion projecting on the sound output side of the diaphragm, and the magnetic circuit may be arranged on the projecting portion and may be housed in a space formed on the sound output side of the diaphragm.

In accordance with this manner, the thickness of the speaker device in the vibrating direction can be small, and by the amount, the speaker device can be thin.

In a preferred example, the vibration system may include a supporting member for supporting the yoke, such as a magnetic circuit holder, arranged on the second plate. The supporting member is preferably formed by a non-magnetic material. In addition, the supporting member may have a space in which the voice coil bobbin can move in a moving direction of the voice coil bobbin. Thereby, the voice coil bobbin can be smoothly driven.

In another manner of the above speaker device, the magnetic circuit may include a yoke, and wherein a buffer member having a buffer function may be provided on an outer peripheral wall of the yoke. In a preferred example, the buffer member can be opposite to the diaphragm with a constant space. Thereby, even when the excessive input signal is inputted to the first and second voice coils from the signal supplying circuit and hence the diaphragm moves to the sound output side with the large magnitude, since the buffer member and the opposite diaphragm collide with each other, it can be avoided that the diaphragm and the magnetic circuit directly collide with each other. As the buffer member, a member having the buffer function such as sponge and urethane is preferred, for example.

In another manner of the above speaker device, a step portion having a flat surface in a direction perpendicular to a moving direction of the diaphragm may be provided in an inner peripheral portion of the diaphragm.

Thereby, at the time of the vibrating of the diaphragm, since strength in the vibrating direction decreases and stiffness becomes small at the step portion, there is such an advantage that the high-frequency-band limit frequency Fh decreases and hence the occurrence of the unnecessary high-frequency component (peak) thereabout can be suppressed (high-cut corrugation operation).

In another manner of the above speaker device, a buffer member having a buffer function and formed into an annular shape maybe provided on the flat surface.

In accordance with this manner, on the flat surface of the step portion, the buffer member having the buffer function and formed into the annular shape is provided. Namely, since the step portion has the flat surface, the buffer member formed into the annular shape can be positioned at the appropriate portion of the diaphragm, and the buffer member can be easily mounted on the flat surface. In addition, when the buffer member is mounted on the flat surface of the step portion by the adhesive, the adhesive never flows to the inner peripheral edge portion side (neck side) of the diaphragm. Namely, since the flat surface of the step portion has the flatness, even if the adhesive is applied to the flat surface of the step portion, the adhesive accumulates on the flat surface of the step portion. Therefore, the adhesive never flows to the inner peripheral edge portion side (neck side) of the diaphragm. Additionally, the buffer member serves as the dustproof member, and can prevent dust entering from the sound output side of the diaphragm from entering the inner side of the magnetic circuit via the gap between the upper end portion of the buffer member and the yoke.

In addition, when the excessive input signal is inputted to the first and second voice coils and hence the diaphragm moves to the sound output side with the large magnitude, the diaphragm approaches the magnetic circuit. However, in this case, since the buffer member and the opposite magnetic circuit contact, it can be prevented that the magnetic circuit and the diaphragm collide with each other. Namely, the buffer member has the function as the cushion member and the dustproof function.

According to still another aspect of the present invention, there is provided a speaker device including a magnetic circuit on a sound output side of the diaphragm; a vibration system including a diaphragm; and a mounting portion to be mounted on a mounting base, wherein the mounting portion is provided at a position corresponding to gravity of the speaker device.

The above-mentioned speaker device includes the magnetic circuit and the vibration system having the diaphragm. In the speaker device, the heavy magnetic circuit in the components thereof is arranged on the sound output side (front side) of the diaphragm. Thus, the gravity of the speaker device is positioned on the sound output side (front side). Particularly, in the speaker device, the mounting portion is provided at the position corresponding to the gravity of the speaker device. In a preferred example, the mounting portion may be positioned on a plan surface including gravity of the speaker device and on a plan surface substantially perpendicular to a vibrating direction of the diaphragm. The mounting portion positioned like that is mounted on the mounting base via the fixing member such as the bolt. Thereby, the speaker device is fixed to the mounting base. As the mounting base, there are a baffle plate of an enclosure and components of a vehicle such as a door and an inner panel of the vehicle.

Thereby, the distance (projecting dimension) that the components of the speaker device project on the sound output side of the diaphragm with respect to the position of the mounting base can be small. Therefore, when the speaker device is mounted on the door and the inner panel of the vehicle for example, the dimension that the components of the speaker device project from the door and the surface of the inner panel to the seat side of the vehicle can be as small as possible. Hence, the speaker device can be easily mounted onto various kinds of places on the vehicle.

In a preferred example, the vibration system may include a frame having a projecting portion projecting on the sound output side of the diaphragm and a flange portion formed into a substantial cup shape and extending outward from a lower end portion of the projecting portion, and the flange portion may have a first flat portion supporting an outer peripheral edge portion of a damper at a substantially middle portion and a second flat portion supporting an outer peripheral edge portion of an edge at an upper end portion thereof. In addition, the mounting portion may be a lower surface of the second flat portion. Namely, the lower surface of the second flat portion of the frame becomes the mounting portion.

In a preferred example, a height from the lower surface of the projecting portion to the mounting portion may be same as a height from the lower surface of the projecting portion to the gravity.

In a manner of the above speaker device, the magnetic circuit may include a first plate, a magnet arranged on the first plate, a second plate arranged on the magnet, and a yoke opposite to each outer peripheral wall of the first plate, the magnet and the second plate with a constant space. In addition, the magnetic circuit may be arranged on the projecting portion, and the mounting portion may be positioned on a plan surface including a substantial center in a thickness direction of the magnet.

In accordance with this manner, the magnetic circuit is arranged on the sound output side (front side) of the diaphragm. Specifically, the magnetic circuit has the first plate, the magnet formed into the annular shape for example, the second plate and the yoke. The magnet is arranged on the first plate, and the surfaces of the magnet corresponding to the first and second plate sides are magnetized into S pole or N pole. The second plate is arranged on the magnet. The yoke is opposite to each outer peripheral wall of the first plate, the magnet and the second plate with the constant space. The magnetic circuit having such a structure is arranged on the sound output side (front side) of the diaphragm, i.e., on the projecting portion being the component of the frame. The mounting portion is positioned on the surface including the substantial center in the thickness direction of the magnet.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a cross-sectional view of a speaker device according to a first embodiment of the present invention;

FIG. 2 is a partly cross-sectional view in which the vicinity of a magnetic circuit system according to the first embodiment is enlarged;

FIGS. 3A and 3B are perspective views showing a bending and folding structure of a lead wire of a voice coil according to the first embodiment;

FIG. 4 is a perspective view showing a bending and folding structure of a lead wire of a voice coil according to a comparative example;

FIG. 5 is a cross-sectional view of a speaker device according to a second embodiment of the present invention;

FIG. 6 is a partly cross-sectional view in which the vicinity of a magnetic circuit according to the second embodiment is enlarged;

FIG. 7 is a graph showing an acoustic characteristic of the speaker device having a diaphragm according to the second embodiment;

FIG. 8 is a graph showing an acoustic characteristic of a speaker device having a diaphragm according to the comparative example;

FIG. 9 is a cross-sectional view of a speaker device according to a third embodiment of the present invention;

FIG. 10 is a partly cross-sectional view in which the vicinity of a magnetic circuit system according to the third embodiment is enlarged; and

FIG. 11 is a graph showing a relation between frequency and vibrating acceleration of the speaker device according to the third embodiment.

### DETAILED DESCRIPTION OF THE PREFERRED EMBODIMENTS

The preferred embodiments of the present invention will now be described below with reference to the attached drawings.

### First Embodiment

(Entire Configuration of Speaker Device)

In this embodiment, the speaker device of the front magnetic circuit system includes the plural magnetic gaps and voice coils, respectively. Thereby, it is intended to prevent collision of the voice coil bobbin and the magnetic circuit. Also, in this embodiment, there is provided a structure of the voice coil device in the speaker device, particularly, a bending and folding structure of the lead wire capable of preventing the cutting of the lead wire of the voice coil.

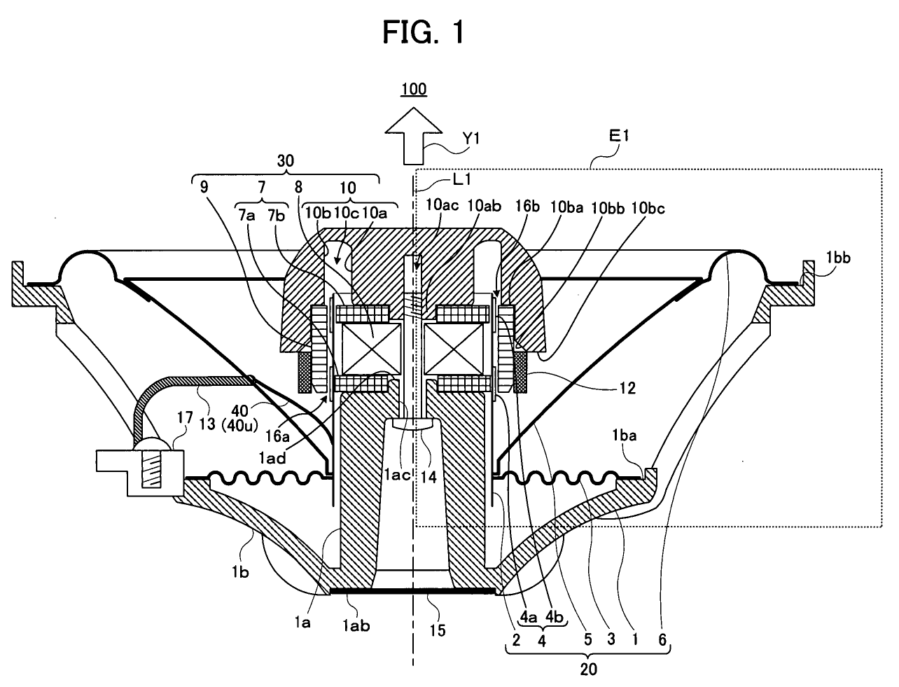

FIG. 1 schematically shows a configuration of a speaker device 100 according to the embodiment of the present invention. The speaker device 100 can be preferably used as an on-vehicle speaker. FIG. 1 shows a cross-sectional view when cutting the speaker device 100 by a plane including a central axis L1 thereof. The description will be given of the configuration of the speaker device 100 of this embodiment, below.

As shown in FIG. 1, the speaker device 100 mainly includes a vibration system 20 having a frame 1, a voice coil bobbin 2, a damper 3, a voice coil 4, a diaphragm 5 and an edge 6, and a magnetic circuit system 30 having a plate 7, a magnet 8, a yoke 9 and a magnetic circuit holder 10. The speaker device 100 further includes a buffer member 12, plural tinsel cords 13, plural terminal members 17, a bolt 14 and a name plate 15, as various kinds of members. The speaker device 100 is a speaker device of the front magnetic circuit system having the magnetic circuit system 30 on a front surface (sound output side) of the diaphragm 5, in consideration of a weight balance.

First, the description will be given of respective components of the vibration system 20.

Various kinds of components of the speaker device 100 are fixed onto the frame 1, and the frame 1 supports the components. The frame 1 has a pole portion 1a and a flange portion 1b extending outward from a lower end portion of an outer peripheral wall of the pole portion 1a with a predetermined inclination.

The pole portion (projecting portion) 1a projects on the sound output side of the diaphragm 5. At a substantially center of an upper end portion of the pole portion 1a, a through hole 1ac into which the bolt 14 is inserted is formed. In the vicinity of the substantially center of the upper surface of the pole portion 1a, an annular projecting portion 1ad projecting on the sound output side is formed. The annular projecting portion 1ad has a function of positioning a first plate 7a at an appropriate position on the pole portion 1a. Meanwhile, at the lower end portion of the pole portion 1a, a recessed portion 1ab formed into a circle is formed. Into the recessed portion 1ab, the name plate 15 formed into a disc-shape, which a trade name and product information are printed on, is mounted.

The cross-section of the flange portion 1b is formed into a substantial cup shape. In addition, the flange portion 1b has a first flat portion 1ba and a second flat portion 1bb, upper surfaces of which ensure flatness. The first flat portion 1ba is formed in the vicinity of a middle portion of the flange portion 1b. On the first flat portion 1ba, an outer peripheral edge portion of the damper 3 is mounted. In addition, on the first flat portion 1ba, the plural terminal members 17 are mounted. The second flat portion 1bb is formed at the upper end portion of the flange portion 1b. On the second flat portion 1bb, an outer peripheral edge portion of the edge 6 is mounted.

The voice coil bobbin 2 is formed into a substantially cylindrical shape. The voice coil 4 is wound around an outer peripheral wall of the voice coil bobbin 2. The voice coil 4 has a first voice coil 4a and a second voice coil 4b, both of which are connected to each other at a predetermined position. The first voice coil 4a is wound around the outer peripheral wall of the voice coil bobbin 2 corresponding to an area in the vicinity of the upper end portion of the pole portion 1a, and the second voice coil 4b is wound around an area in the vicinity of the upper end portion of the outer peripheral wall of the voice coil bobbin 2. The first voice coil 4a and the second voice coil 4b may be electrically independently structured, respectively.

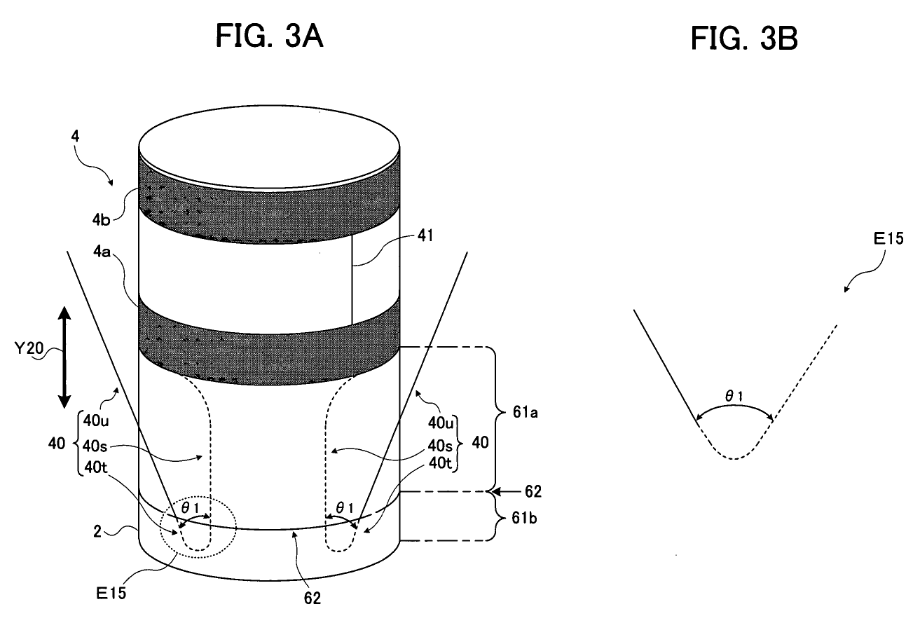

The first voice coil 4a and the second voice coil 4b are wound around the outer peripheral wall of the voice coil bobbin 2 with a constant space therebetween. A winding direction of the first voice coil 4a around the voice coil bobbin 2 is opposite to a winding direction of the second voice coil 4b around the voice coil bobbin 2. Further, an effective line length of the first voice coil 4a and an effective line length of the second voice coil 4b are the same. A first wound member 61a and a second wound member 61b (see FIG. 3A) are attached to the outer peripheral wall of the voice coil bobbin 2, which will be explained later.

A lead wire 40 is wound around the outer peripheral wall of the voice coil bobbin 2, which constitutes the voice coil 4. By a bending and folding method described later, the lead wire 40 is bent and folded to the front side (sound output side) of the diaphragm 5 to be electrically connected to one end side of each tinsel cord 13 drawn to the front side (sound output side) of the diaphragm 5. Meanwhile, other end side of each tinsel cord 13 is electrically connected to one end side of each terminal member 17 positioned on the first flat portion 1ba of the frame 1. Also, other end side of each terminal member 17 is electrically connected to each of correspondent input wires of the amplifier. Therefore, the electric signal is inputted to the voice coil 4 from the signal supplying circuit of the amplifier via each of the correspondent terminal members 17, each tinsel cord 13 and the lead wire 40.

The damper 3 is formed into a substantial annular shape, and has an elastic portion formed with concentric corrugations. The outer peripheral edge portion of the damper 3 is fixed onto the first flat portion 1ba of the frame 1, and the inner peripheral edge portion of the damper 3 is fixed to the lower end portion of the outer peripheral wall of the voice coil bobbin 2.

Various kinds of materials such as paper, high polymer and metal can be applied to the diaphragm 5 in accordance with various use purposes. The diaphragm 5 is a cone-shape diaphragm, and a cross-section thereof is curved like a bow, i.e., formed into a so-called paracurved shape. The inner peripheral edge portion of the diaphragm 5 is mounted at a position in the vicinity of the inner peripheral edge portion of the damper 3 and at a position in the vicinity of the lower end portion of the outer peripheral wall of the voice coil bobbin 2.

The cross-section of the edge 6 is formed into a substantial half-circle. The inner peripheral edge portion of the edge 6 is fixed to the lower surface side of the outer peripheral portion of the diaphragm 5, and the lower surface of the outer peripheral edge portion of the edge 6 is fixed to the second flat portion 1bb of the frame 1.

(Magnetic Circuit System)

Next, the description will be given of each component of the magnetic circuit system 30.

The magnetic circuit holder 10 formed into a mushroom shape is formed by a non-magnetic material. The magnetic circuit holder 10 has a projecting portion 10a, a cylindrical portion 10b and a gap 10c.

The projecting portion 10a is formed into a substantially cylindrical shape, and projects on the side of a second plate 7b. At the substantial center portion of the lower surface of the projecting portion 10a, an annular projecting potion 10ab projecting on the side of the magnet 8 is formed. At the substantially center portions of the projecting portion 10a and the annular projecting portion 10ab, a screw hole 10ac for fixing the bolt 14 is formed. The cylindrical portion 10b is formed into a substantially cylindrical shape. An inner diameter of the cylindrical portion 10b corresponding to the area from the substantially middle portion of the cylindrical portion 10b to the upper end portion thereof is smaller than an inner diameter of the cylindrical portion 10b corresponding to the area from the substantially middle portion of the cylindrical portion 10b to the lower end portion thereof. Therefore, at the substantially middle portion of the inner peripheral wall of the cylindrical portion 10b, a step portion 10ba is formed. In addition, the gap 10c is formed between the inner peripheral wall of the cylindrical portion 10b and the outer peripheral wall of the projecting portion 10a. The gap 10c is a space in which the voice coil bobbin 2 moves. A cut-out portion 10bb is formed at the lower end portion on the inner peripheral wall of the cylindrical portion 10b by cutting out a portion thereof. Therefore, a space is formed between the cut-out portion 10bb and the opposite yoke 9.

The plate 7 has the first plate 7a and the second plate 7b which are formed into a substantially annular shape. The inner peripheral wall of the first plate 7a contacts the outer peripheral wall of the annular projecting portion 1ad, and the lower surface of the first plate 7a is fixed onto the upper surface of the pole portion 1a. Thereby, the first plate 7a is positioned at the appropriate position on the pole portion 1a to be fixed onto the pole portion 1a. The magnet 8 formed into an annular shape is fixed onto the first plate 7a. Both surfaces (upper surface and lower surface) of the magnet 8 are magnetized into S pole or N pole. The second plate 7b is fixed onto the magnet 8 at the position corresponding to the first plate 7a. The first plate 7a, the magnet 8 and the second plate 7b are housed in the voice coil bobbin 2.

The yoke 9 is formed into a substantial annular shape, and has an inner diameter larger than an outer diameter of the voice coil bobbin 2. The yoke 9 is fixed to the step portion 10ba of the cylindrical portion 10b and the inner peripheral wall of the cylindrical portion 10b positioned on the lower side of the drawing with respect to the step portion 10ba. Thus, the yoke 9 is supported by the magnetic circuit holder 10. Onto a part of the outer peripheral wall of the yoke 9, the buffer member 12 formed into an annular shape is mounted. Namely, the buffer member 12 is mounted onto the lower end portion on the outer peripheral wall of the yoke 9 in such a manner that a part of the upper surface of the buffer member 12 contacts a part of the lower surface 10bc of the cylindrical portion 10b. The buffer member 12 has a function of preventing the diaphragm 5 from directly contacting the magnetic circuit system 30 when the electric signal with the large magnitude is inputted. The reason why the buffer member 12 is mounted onto such a position is to prevent the diaphragm 5 from contacting (interfering) the buffer member 12 when the diaphragm 5 moves based on the appropriate electric signal. As the buffer member 12, a member having a buffer function such as urethane and sponge is preferred, for example.

The magnetic circuit holder 10 onto which the yoke 9 is mounted is fixed onto the second plate 7b. Specifically, the annular projecting portion 10ab of the magnetic circuit holder 10 is inserted into the opening of the second plate 7b, and the outer peripheral wall of the annular projecting portion 10ab contacts the inner peripheral wall of the second plate 7b. A part of the lower surface of the projecting portion 10a contacts the upper surface of the second plate 7b. In addition, the bolt 14 is inserted in to each of the openings of the pole portion 1a of the frame 1, the first plate 7a, the magnet 8 and the second plate 7b in the direction of an arrow Y1. A point portion of the bolt 14 is fixed to the screw hole 10ac of the projecting portion 10a. In this manner, the magnetic circuit holder 10 onto which the yoke 9 is mounted is fixed onto the second plate 7b.

In such a state, the vicinity of the upper end portion of the inner peripheral wall of the yoke 9 is opposite to the outer peripheral walls of the second plate 7b and the magnet 8 with a constant space, and a gap (second magnetic gap 16b) is formed therebetween. On the contrary, the vicinity of the lower end portion of the inner peripheral wall of the yoke 9 is opposite to the outer peripheral walls of the first plate 7a and the magnet 8 with a constant space, and a gap (first magnetic gap 16a) is formed therebetween. Namely, the magnetic circuit system 30 has the first magnetic gap 16a and the second magnetic gap 16b, and further has the first voice coil 4a and the second voice coil 4b corresponding to them, respectively (i.e., 2-magnetic gaps and 2-voice coils system). In the magnetic circuit system 30, a magnetic flux of the magnet 8 is concentrated on the second magnetic gap 16b and the first magnetic gap 16a. Specifically, in the magnetic circuit system 30, there is formed a magnetic circuit (magnetic field) as follows: the magnet 8→the first plate 7a→the first magnetic gap 16a→the yoke 9→the second magnetic gap 16b→the second plate 7b→the magnet 8. It is noted that a group of the first plate 7a and the first magnetic gap 16a and a group of the second plate 7b and the second magnetic gap 16b are equivalent and thus the order of them may be interchanged. Moreover, in the magnetic circuit system 30, the direction of the magnetic field formed in the vicinity of the first plate 7a, the magnet 8 and the yoke 9 is opposite to the direction of the magnetic field formed in the vicinity of the second plate 7b, the magnet 8 and the yoke 9, which will be explained later.

In the above-mentioned speaker device 100, the electric signal outputted from the amplifier is outputted to the first voice coil 4a and the second voice coil 4b via each of the terminal members 17, each of the tinsel cords 13 and the lead wire 40. Thereby, the same driving force in the same direction occurs to the first voice coil 4a in the first magnetic gap 16a and to the second voice coil 4b in the second magnetic gap 16b, respectively, and the driving force vibrates the diaphragm 5 in the axis direction of the speaker device 100. In this way, the speaker device 100 emits the acoustic wave in the direction of the arrow Y1.

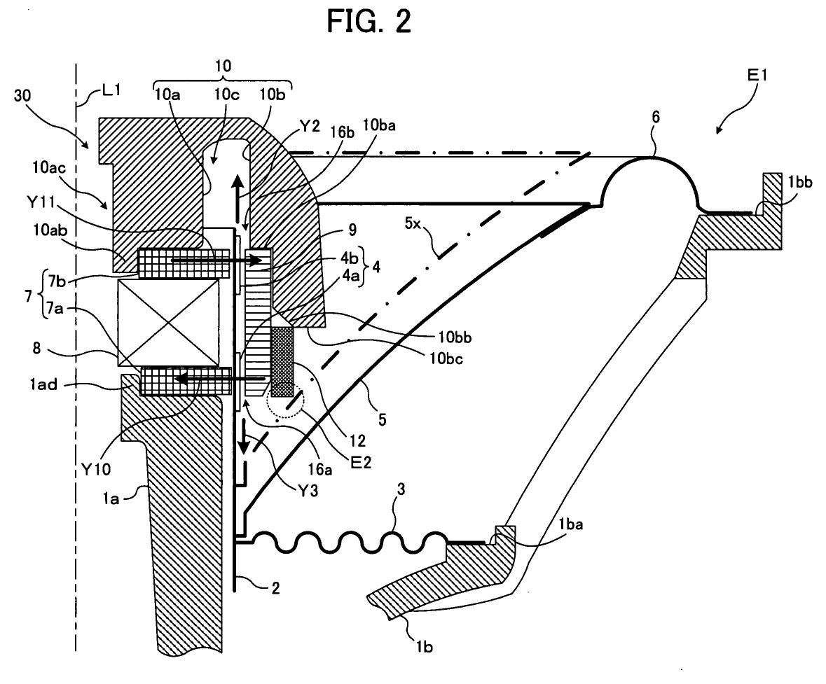

FIG. 2 shows a cross-sectional view in which a broken line area E1 shown in FIG. 1 is enlarged.

As described above, the magnetic circuit system 30 of the 2-magnetic gaps and 2-voice coils system is employed in this embodiment.

Namely, the first magnetic gap 16a is formed between the outer peripheral wall of the first plate 7a and the area in the vicinity of the lower end portion of the inner peripheral wall of the yoke 9. The first voice coil 4a is wound around the outer peripheral wall of the voice coil bobbin 2 corresponding to the area in the vicinity of the upper end portion of the pole portion 1a, and the first voice coil 4a is arranged at the position corresponding to the first magnetic gap 16a. The first voice coil 4a is wound in a clockwise direction when the speaker device 100 is observed in the direction opposite to the arrow Y1 shown in FIG. 1. In addition, the magnetic field in the vicinity of the first plate 7a, the magnet 8 and the yoke 9 (i.e., the magnetic field in the vicinity of the first magnetic gap 16a) is generated in the direction of an arrow Y10.

On the other hand, a second magnetic gap 16b is formed between the outer peripheral wall of the second plate 7b and the vicinity of the upper end portion of the inner peripheral wall of the yoke 9. The second voice coil 4b is wound around the vicinity of the upper end portion of the outer peripheral wall of the voice coil bobbin 2 to be arranged at a position corresponding to the second magnetic gap 16b. The second voice coil 4b is wound in the anticlockwise direction when the speaker device 100 is observed in the direction opposite to the arrow Y1 shown in FIG. 1, and the winding direction is opposite to the winding direction of the first voice coil 4a. In addition, the magnetic field in the vicinity of the second plate 7b, the magnet 8 and the yoke 9 (i.e., the magnetic field in the vicinity of the second magnetic gap 16b) is generated in the direction of an arrow Y11 (in the direction opposite to the arrow Y10).

It is noted that, in another embodiment, the direction of the magnetic field generated in the vicinity of the first magnetic gap 16a may be set to the direction of the arrow Y11, and the direction of the magnetic field generated in the vicinity of the second magnetic gap 16b may be set to the direction of the arrow Y10, respectively. Moreover, the effective line length of the second voice coil 4b is set the same as the effective line length of the first voice coil 4a. According to the above structure, the first and second voice coils 4a and 4b can be moved in the same direction with the same strength, respectively.

In such a speaker device 100, when the electric signal having the same level and phase is supplied to the first and second voice coils 4a and 4b from the signal supplying circuit of the amplifier, respectively, the voice coil bobbin 2 vibrates in the directions of the arrows Y2 and Y3. At this time, the upper end portion of the voice coil bobbin 2 moves in the gap 10c of the magnetic circuit holder 10 in the directions of the arrows Y2 and Y3.

When the excessive input signal is inputted to the voice coil 4 due to a cause of some sort, the voice coil bobbin 2 vibrates in the directions of the arrows Y2 and Y3 with the large magnitude. Namely, when it is assumed that the excessive input signal is inputted to the voice coil 4 and hence the voice coil bobbin 2 moves in the direction of the arrow Y3 with the large magnitude, the vicinity of the lower end portion of the second voice coil 4b is positioned in the first magnetic gap 16a. Thereby, since the second voice coil 4b is affected by the magnetic field in the first magnetic gap 16a, and the force (damping force) in the direction of the arrow Y2 operates on the second voice coil 4b in accordance with Fleming's left-hand rule. Namely, at this time, since the second voice coil 4b moves in the direction of the arrow Y2, it is restricted that the voice coil bobbin 2 moves in the direction of the arrow Y3 with the large magnitude. Thereby, it is prevented that the voice coil bobbin 2 moves in the direction of the arrow Y3 with the large magnitude and hence the lower end portion of the voice coil bobbin 2 collides with the opposite frame 1 (see FIG. 1).

On the other hand, when it is assumed that the excessive input signal is inputted to the voice coil 4 and hence the voice coil bobbin 2 moves in the direction of the arrow Y2 with the large magnitude, the vicinity of the upper end portion of the first voice coil 4a is positioned in the second magnetic gap 16b. Thereby, the first voice coil 4a is affected by the magnetic field in the second magnetic gap 16b, and the force (damping force) in the direction of the arrow Y3 operates on the first voice coil 4a in accordance with the Fleming's left-hand rule. Namely, at this time, since the first voice coil 4a moves in the direction of the arrow Y3, it is restricted that the voice coil bobbin 2 moves in the direction of the arrow Y2 with the large magnitude. Thereby, it can be prevented that the voice coil bobbin 2 moves in the direction of the arrow Y2 with the large magnitude and hence the upper end portion of the voice coil bobbin 2 collides with the opposite magnetic circuit holder 10 (see FIG. 1).

As described above, since the speaker device 100 according to this embodiment employs the magnetic circuit system 30 of the 2-magnetic gaps and 2-voice coils system, even when the excessive input signal is inputted to the voice coil 4 from the signal supplying circuit of the amplifier, it can be suppressed that the voice coil bobbin 2, the magnetic circuit system 30, the frame 1 and the magnetic circuit holder 10 collide with each other.

In addition, the diaphragm 5 formed into the so-called paracurved shape is applied to the speaker device 100. Namely, the cross-sectional shape of the diaphragm 5 is curved to project on the sound output side, as shown in FIG. 2. Therefore, when the excessive input signal is inputted to the voice coil 4, since the diaphragm 5 moves in the direction of the arrow Y2 with the large magnitude, a part of the upper surface of the diaphragm 5 easily collides with the opposite yoke 9 and magnetic circuit holder 10.

In this point, in the speaker device 100 according to this embodiment, the buffer member 12 having the buffer function is provided in the vicinity of the lower end portion of the outer peripheral wall of the yoke 9. Therefore, when the diaphragm 5 moves in the direction of the arrow Y2 with the large magnitude, the lower end portion of the buffer member 12 contacts the opposite part of the upper surface of the diaphragm 5. Namely, in this case, the diaphragm 5 moves to a position of a diaphragm 5x shown by a chain line for example, and the lower end portion of the buffer member 12 contacts the opposite part of the upper surface of the diaphragm 5. Thereby, it can be avoided that the part of the upper surface of the diaphragm 5 directly collides with the opposite yoke 9 and the opposite cylindrical portion 10b of the magnetic circuit holder 10. Thus, the damage of the diaphragm 5 can be prevented.

Additionally, in the speaker device 100, the magnetic circuit system 30 is arranged on the pole portion 1a of the frame 1 so that the magnetic circuit system 30 is housed in the space formed on the upper side (sound output side) of the diaphragm 5. Thereby, it can be avoided that the magnetic circuit system 30 needlessly projects in the upper side direction with respect to the upper end portion of the diaphragm 5. Further, as shown in FIG. 1, a distance D1 of the vibrating direction of the speaker device 100 can be small. Namely, the speaker device 100 can be thin.

Since the diaphragm 5 formed into the above-mentioned paracurved shape is applied to the speaker device 100 according to this embodiment, the unnecessary high-frequency component (peak) does not occur around the high-frequency-band limit frequency Fh, and it becomes possible to obtain the flat sound pressure characteristic.

(Voice Coil Device)

Next, the description will be given of the structure of the voice coil device, specifically, a bending and folding structure of the lead wire 40 of the voice coil 4, with reference to FIGS. 3A and 3B. FIG. 3A is a perspective view showing the structure of the voice coil device shown in FIG. 1, which shows the bending and folding structure of the lead wire 40 of the voice coil 4 of the present invention. FIG. 3B shows an enlarged view of the vicinity of the lead wire 40 in a broken line area E15 shown in FIG. 3A, i.e., the vicinity of a bent portion 40t.

As shown in FIG. 3A, the voice coil device includes the voice coil bobbin 2, the voice coil 4 formed by winding the lead wire 40 around the outer peripheral wall of the voice coil bobbin 2, the first wound member 61a and the second wound member 61b attached to the outer peripheral wall of the voice coil bobbin 2 to cover a part of the lead wire 40 of the voice coil 4. The first wound member 61a and the second wound member 61b are formed into band shapes, each one side of which the adhesive is applied to. As the first wound member 61a and the second wound member 61b, a material capable of being freely bent and having durability, such as band paper and tape, is preferred.

Specifically, the voice coil 4 includes the first voice coil 4a and the second voice coil 4b, which are wound around the outer peripheral wall of the voice coil bobbin 2 in the axis direction of the voice coil bobbin 2 with the constant space. Namely, the second voice coil 4b is wound around the upper end portion of the outer peripheral wall of the voice coil bobbin 2, and the first voice coil 4a is wound around the vicinity of the middle portion of the outer peripheral wall of the voice coil bobbin 2. In addition, the first voice coil 4a and the second voice coil 4b are connected to each other at a connecting portion 41 positioned therebetween. Namely, the first voice coil 4a and the second voice coil 4b are electrically connected.

The lead wire 40 includes a drawn portion 40s drawn from the lower end of the first voice coil 4a, a bent portion 40t extending from one end of the drawn portion 40s and bent at a bending angle θ1 to be formed into a gently curved shape, and an external portion 40u extending outward from a predetermined position of one end of the bent portion 40t.

The drawn portion 40s extends from the lower end of the first voice coil 4a to the position in the vicinity of the lower end portion thereof along the outer peripheral wall of the voice coil bobbin 2. The bent portion 40t extends from the one end of the drawn portion 40s and is gently curved and bent into the curve shape in the vicinity of the lower end portion of the outer peripheral wall of the voice coil bobbin 2, as shown in the broken line area E15. It is preferred that the bending angle θ1 is an angle (an acute angle is further preferred) gently curved into the curved shape as shown in FIG. 3B. The external portion 40u extends outward from the predetermined position of the one end of the bent portion 40t.

The first wound member 61a and the second wound member 61b divide the voice coil bobbin 2 into two parts in the axis direction thereof, and are attached to the outer peripheral wall of the voice coil bobbin 2 to cover the part of the lead wire 40 of the voice coil 4. The first wound member 61a and the second wound member 61b do not overlap with each other. Therefore, a border portion 62 from which the lead wire 40 is drawn out is formed between the first wound member 61a and the second wound member 61b. In addition, the length of the first wound member 61a in the axis direction of the voice coil bobbin 2 is longer than the length of the second wound member 61b in the same direction. In this manner, in the voice coil device of this embodiment, since the first wound member 61a and the second wound member 61b are attached to the outer peripheral wall of the voice coil bobbin 2, rigidity of the voice coil bobbin 2 becomes high.

The first wound member 61a is attached to the outer peripheral wall of the voice coil bobbin 2 to cover the drawn portion 40s. Thus, the drawn portion 40s is fixed to the outer peripheral wall of the voice coil bobbin 2 by the first wound member 61a.

The second wound member 61b is attached to the outer peripheral wall of the voice coil bobbin 2 to cover the bent portion 40t. Thus, the bent portion 40t is fixed to the outer peripheral wall of the voice coil bobbin 2 by the second wound member 61b. The external portion 40u is drawn out to external from a predetermined position, specifically, from the border portion 62 between the first wound member 61a and the second wound member 61b (it corresponds to a solid line portion of the lead wire 40).

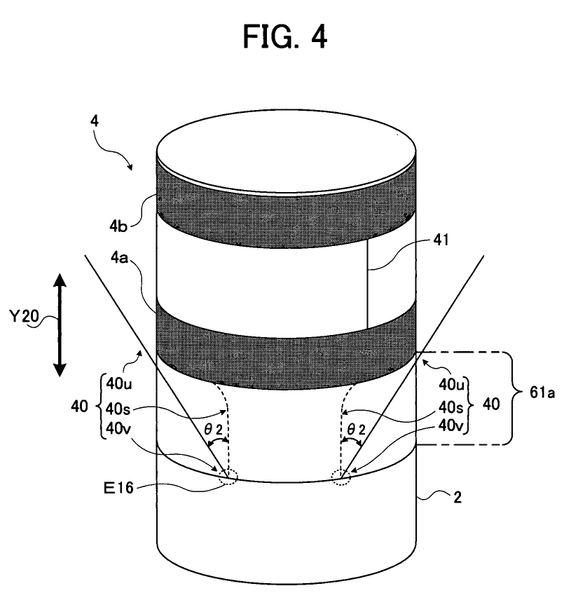

Next, the description will be given of operation and effect of the present invention compared with a comparative example, with reference to FIG. 1, FIGS. 3A and 3B and FIG. 4. FIG. 4 is a perspective view corresponding to FIG. 3A, which shows the structure of the voice coil device 4 according to the comparative example, i.e., the bending and folding structure of the leadwire 40. In FIG. 4, the same reference numerals are given to the same components as those of this embodiment, explanation of which will be omitted.

First, the description will be given of the bending and folding structure of the lead wire 40 of the voice coil 4 according to the comparative example.

As shown in FIG. 4, the first voice coil 4a and the second voice coil 4b are wound around the outer peripheral wall of the voice coil bobbin 2 by the same structure as this embodiment. The lead wire 40 includes the drawn portion 40s drawn from the lower end of the first voice coil 4a, a bent portion 40v (a portion corresponding to a broken line area E16) extending from one end of the drawn portion 40s and bent at a bending angle θ2 corresponding to the acute angle at the one end, and an external portion 40u extending outward from one end of the bent portion 40v.

The first wound member 61a is attached to the outer peripheral wall of the voice coil bobbin 2 to cover the drawn portion 40s and the part of the bent portion 40v. Therefore, those components are fixed to the outer peripheral wall of the voice coil bobbin 2 by the first wound member 61a, respectively. Unlike the embodiment, the second wound member 61b is not attached to the lower end portion of the outer peripheral wall of the voice coil bobbin 2 in the comparative example.

In the speaker device (not shown) according to the comparative example, at the time of driving the voice coil device, the voice coil device vibrates in the axis direction, i.e., in the direction of an arrow Y20, as shown in FIG. 4. In the comparative example, since the bent portion 40v is bent at the bending angle θ2 corresponding to the acute angle at the lower end portion of the first wound member 61a, at the time of the driving of the voice coil device, tinsel stress and bending stress repeatedly operate on the bent portion 40v, and the lead wire 40 may be cut at the bent portion 40v.

On the other hand, in the speaker device 100 according to this embodiment, as shown in FIG. 3A, the voice coil device vibrates in the direction of the arrow Y20 at the time of the driving, similarly to the case of the comparative example. However, the above-mentioned problem of the comparative example does not occur.

Namely, in this embodiment, particularly, the bent portion 40t of the lead wire 40 is bent at the bending angle θ1 gently curved into the curved shape. Then, the bent portion 40t is fixed by the second wound member 61b in a state that the bending angle θ1 is not changed. Thus, when the voice coil device is driven in the direction of the arrow Y20, the stress of cutting of the lead wire 40 does not operate on the bent portion 40t. That is, the stress does not concentrate on the bent portion 40t. Therefore, the cutting of the lead wire 40 of the voice coil 4 can be prevented.

Additionally, the drawn portion 40s is fixed to the outer peripheral wall of the voice coil bobbin 2 by the first wound member 61a, and the bent portion 40t is fixed to the outer peripheral wall of the voice coil bobbin 2 by the second wound member 61b. Thereby, at the time of the driving of the voice coil device, it is prevented that the drawn portion 40s and the bent portion 40t move with respect to the voice coil bobbin 2. Hence, at the time of the driving, it can be suppressed that the stress of cutting of them operates on the components, and the cutting of the components can be prevented.

Since the external portion 40u extends from the one end of the bent portion 40t and is drawn outward from the border portion 62 between the first wound member 61a and the second wound member 61b, the external portion 40u and the tinsel cord 13 can be easily electrically connected to each other.

As shown in FIG. 1, the external portion 40u, which is curved, is electrically connected to the one end of the tinsel cord 13 drawn on the sound output side of the diaphragm 5. Thereby, at the time of the driving of the speaker device 100, since the external portion 40u formed into the curved shape is freely deformed with the movement of the voice coil device, the stress of cutting it does not operate on the external portion 40u. Hence, the cutting of the external portion 40u can be prevented.

(Modification)

In this embodiment, the voice coil device includes two wound members, i.e., the first wound member 61a and the second wound member 61b. However, this invention is not limited to this. In this invention, the first wound member 61a and the second wound member 61b may be structured by plural wound members, respectively.

In the above-mentioned embodiment, the voice coil device of this invention is applied to the speaker device 100 of the front magnetic circuit system in which the magnetic circuit system 30 is arranged on the sound output side (front side) of the diaphragm. However, this invention is not limited to this. Namely, the voice coil device of the present invention may be applied to the speaker device 100 of a rear magnetic circuit system in which the magnetic circuit system 30 is arranged on the rear side (side opposite to the sound output side) of the diaphragm.

### Second Embodiment

Similarly to the first embodiment, in a second embodiment, plural magnetic gaps and voice coils are provided in the speaker device of the front magnetic circuit system so that collision of the voice coil bobbin and the magnetic circuit is prevented. Additionally, in the second embodiment, the step portion having the upper surface on which flatness is ensured is provided on the inner peripheral portion (neck portion) of the diaphragm. Thereby, the unnecessary high-frequency component (peak) around the high-frequency-band limit frequency Fh can be suppressed, and attachment work of the buffer member having the buffer function and the dustproof function can be easier.

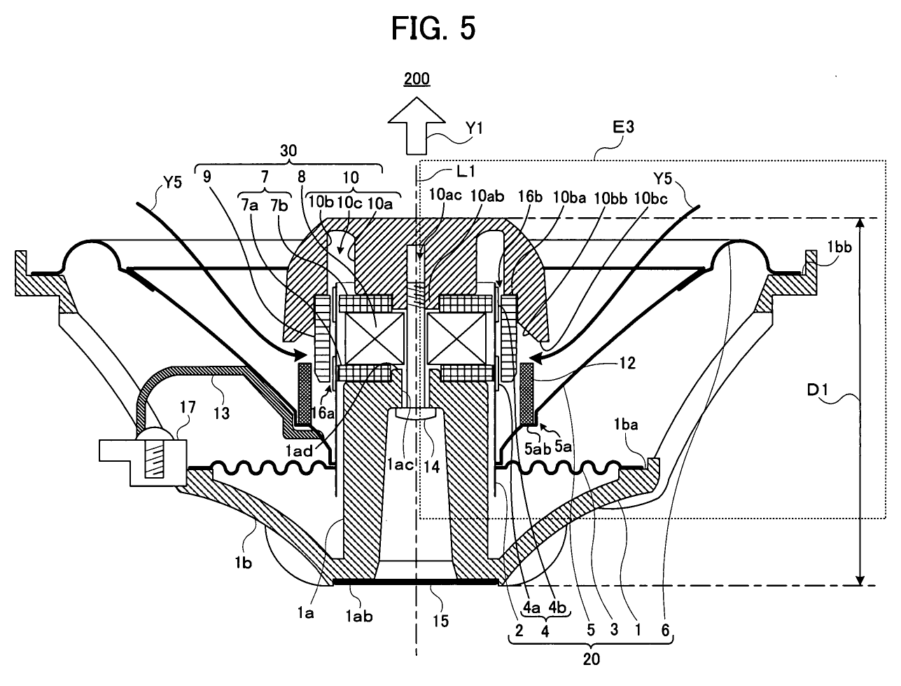

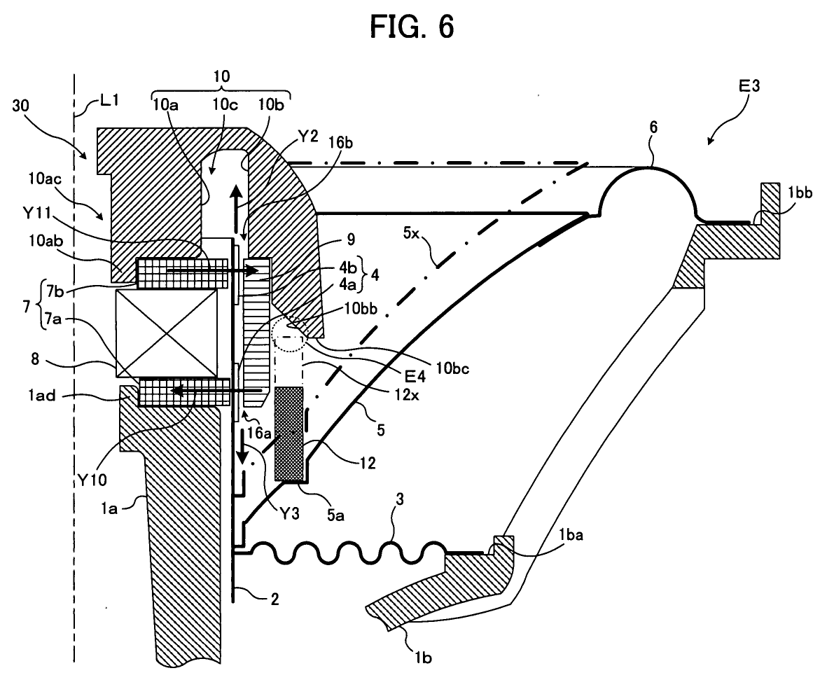

Next, the description will be given of a configuration of a speaker device 200 according to the second embodiment with reference to FIG. 5 and FIG. 6. The same reference numerals are given to the same components as those of the speaker device 100 of the first embodiment, the explanation of which will be omitted. FIG. 5 shows a cross-sectional view when cutting the speaker device 200 according to the second embodiment by a plane including a central axis L1 thereof. FIG. 6 shows a partly cross-sectional view corresponding to a broken line area E3 shown in FIG. 5.

The configuration of the speaker device 200 according to the second embodiment is basically similar to the configuration of the speaker device 100 according to the first embodiment. However, both of them are different in the structure of the diaphragm 5, the shape of the cylindrical portion 10b of the magnetic circuit holder 10, the mounting position of the buffer member 12 and the method of drawing the tinsel cord 13. Particularly, the speaker device 200 according to the second embodiment has a characteristic in the structure of the diaphragm 5.

Specifically, in the speaker device 200 in the second embodiment, a step portion 5a formed into a step shape is formed in the vicinity of the inner peripheral portion (neck) of the diaphragm 5. An upper surface 5ab of the step portion 5 has flatness. The buffer member 12 is mounted onto the upper surface 5ab of the step portion 5a by an adhesive (not shown). Namely, in the first embodiment, the buffer member 12 is mounted onto the outer peripheral wall of the yoke 9. However, in the second embodiment, the buffer member 12 is mounted onto the upper surface 5ab of the step portion 5a of the diaphragm 5. In addition, in the second embodiment, by mounting the buffer member 12 onto the upper surface 5ab of the step portion 5a, each one end side of the plural tinsel cords 13 is drawn to the position on the lower side of the step portion 5a of the diaphragm 5 and to the upper side (sound output side) of the diaphragm 5. Each one end side of the tinsel cords 13 is electrically connected to each of the lead wires (not shown) of the correspondent first voice coil 4a and second voice coil 4b, respectively.

At the lower end portion of the inner peripheral wall of the cylindrical portion 10b of the magnetic circuit holder 10, the cut-out portion 10bb is formed by cutting out a part thereof. The cut-out size of the cut-out portion 10bb of the second embodiment is larger than that of the first embodiment. Therefore, the space formed between the cut-out portion 10bb of the second embodiment and the outer peripheral wall of the yoke 9 is larger than the corresponding space of the first embodiment. The reason is as follows. As described above, in the second embodiment, the buffer member 12 is mounted onto the upper surface 5ab of the step portion 5a of the diaphragm 5, not onto the side of the magnetic circuit system 30. Therefore, when the diaphragm 5 moves in the direction of the arrow Y2, the buffer member 12 accordingly moves in the same direction, too. At this time, if the buffer member 12 collides with the opposite cylindrical portion 10b of the magnetic circuit holder 10, the appropriate acoustic wave cannot be emitted. Hence, the cut-out size of the cut-out portion 10bb in the second embodiment is made larger than that of the first embodiment so that the buffer member 12 does not collide with the cylindrical portion 10b at the time of the driving based on the appropriate electric signal. Namely, when the diaphragm 5 moves based on the appropriate electric signal, it is prevented that the upper end portion of the buffer member 12 and the opposite cylindrical portion 10a interfere with each other.

The above-mentioned speaker device 200 has operation and effect as follows.

First, since the speaker device 200 according to the second embodiment employs the 2-magnetic gaps and 2-voice coils system similarly to the first embodiment, even when the excessive input signal is inputted to the voice coil 4, it can be suppressed that the voice coil bobbin 2 collides with the magnetic circuit system 30, the frame 1 and the magnetic circuit holder 10.

In addition, in the speaker device 200 according to the second embodiment, the step portion 5a having the upper surface 5ab on which the flatness is ensured is provided in the vicinity of the inner peripheral portion of the diaphragm 5. Thereby, the buffer member 12 formed into the annular shape can be positioned at the appropriate position of the diaphragm 5, and the buffer member 12 can be easily mounted onto the upper surface 5ab. When the buffer member 12 is mounted onto the upper surface 5ab of the step portion 5a by the adhesive, the adhesive never flows to the side of the inner peripheral edge portion of the diaphragm 5. Namely, since the upper surface 5ab of the step portion 5a has the flatness, even when the adhesive is applied to the upper surface 5ab of the step portion 5a, the adhesive accumulates on the upper surface 5ab of the step portion 5a. That is, the adhesive never flows down to the side of the inner peripheral edge portion of the diaphragm 5.

Since the annular buffer member 12 is mounted onto the upper surface 5ab of the step portion 5a, the space formed among the buffer member 12, the yoke 9, the first voice coil 4a, the voice coil bobbin 2 and the diaphragm 5 is substantially closed. Thus, it can be prevented that the dust entering from the sound output side of the diaphragm 5, i.e., from the direction of the arrow Y5 shown in FIG. 5, enters the magnetic circuit system 30 via the gap between the upper end portion of the buffer member 12 and the cylindrical portion 10b of the yoke 9.

If the buffer member 12 and the yoke 9 contact at the time of the driving of the speaker device 200, the appropriate acoustic wave cannot be emitted. Hence, a small gap is formed between the upper end portion on the inner peripheral wall of the buffer member 12 and the vicinity of the lower end portion of the outer peripheral wall of the yoke 9.

In addition, as shown in FIG. 6, when it is assumed that the excessive input signal is inputted to the voice coil 4 and hence the diaphragm 5 moves in the direction of the arrow Y2 with the large magnitude, the diaphragm 5 positioned at the solid line position in the still state moves to the position of the diaphragm 5x shown by the chain line. At this time, the vicinity of the inner peripheral portion of the diaphragm 5 approaches the lower end portion of the yoke 9 and the lower end portion of the cylindrical portion 10b of the magnetic circuit holder 10. However, in this case, the buffer member 12 positioned at the solid line position in the still state moves to the position of the buffer member 12x shown by the chain line, and the buffer member 12x contacts the opposite lower end portion of the cylindrical portion 10b of the magnetic circuit holder 10. Thereby, it can be prevented that the yoke 9 and the magnetic circuit holder 10 directly collide with the part of the opposite upper surface of the diaphragm 5. Therefore, the damage of the diaphragm 5 can be prevented. Namely, the buffer member 12 of the second embodiment has both of the buffer function as the cushion member and the dustproof function.

As described above, the step portion 5a is formed at the inner peripheral portion of the diaphragm 5. Particularly, the upper surface 5ab of the step portion 5a has the flatness in the direction perpendicular to the vibrating direction (the directions of the arrows Y2 and Y3) of the diaphragm 5. Thereby, at the time of the driving of the speaker device 200, the occurrence of the unnecessary high-frequency component (peak) around the high-frequency-band limit frequency Fh can be prevented.

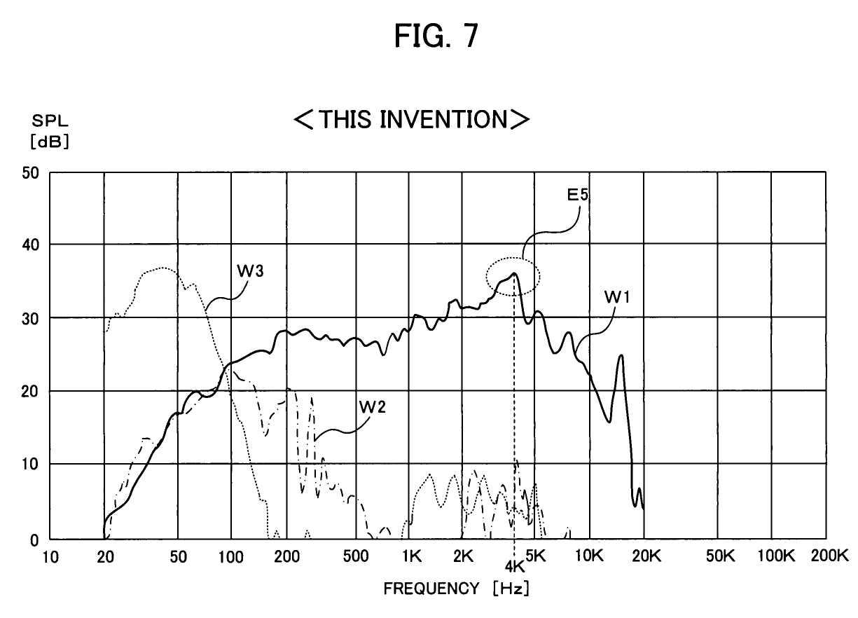

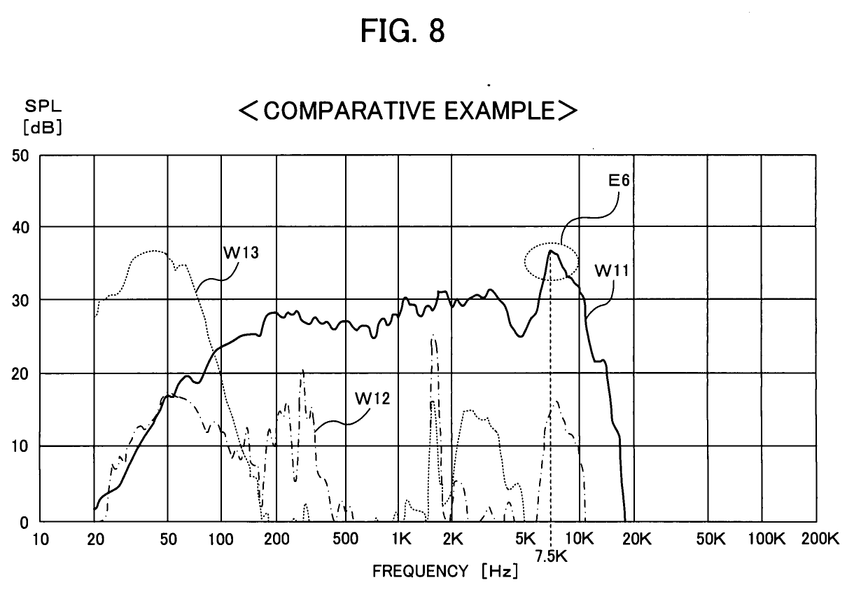

This point will be explained compared with the acoustic characteristic of the speaker device according to the comparative example. FIG. 7 is a graph showing the acoustic characteristic of the speaker device 200 according to the second embodiment in which the vertical axis indicates a sound pressure level (SPL) and the horizontal axis indicates frequency (Hz), respectively. Additionally, in FIG. 7, graphs W1, W2 and W3 show a fundamental wave characteristic, a secondary harmonic distortion characteristic and a tertiary harmonic distortion characteristic, respectively. FIG. 8 is a graph showing the acoustic characteristic of the speaker device according to the comparative example, corresponding to FIG. 7. The graph of FIG. 8 is measured on the same condition as the present invention. In FIG. 8, graphs W11, W12 and W13 show a fundamental wave characteristic, a secondary harmonic distortion characteristic and a tertiary harmonic distortion characteristic, respectively.

Though the illustration of the speaker device according to the comparative example is omitted, the configuration thereof will be briefly explained. Namely, the speaker device according to the comparative example employs the front magnetic circuit system and the 1-magnetic gap and 1-voice coil system (similar to the system shown in FIG. 1 in which the second voice coil 4b is removed). Further, the cross-section of the diaphragm is formed into the straight shape, and no step portion is formed at the inner peripheral portion thereof.

As shown by the graph W1 in FIG. 7, in the speaker device 200 of the second embodiment, the flat sound pressure level is obtained in the frequency band between about 180 Hz and about 3 KHz. Additionally, as shown by the graph W1 in FIG. 7, in the speaker device 200, the high-frequency-band limit frequency Fh is about 4 KHz, and the sound pressure level of the high-frequency-band limit frequency Fh is about 36 (dB). The high-frequency-band limit frequency Fh is the frequency at which the vibration of the voice coil bobbin 7 is not transmitted to the diaphragm 5. Meanwhile, as shown by the graph W11 of FIG. 8, in the speaker device according to the comparative example, the flat sound pressure level is obtained in the frequency band between about 180 Hz and about 3 KHz, similarly to the speaker device 200 of the second embodiment. In addition, as shown by the graph W11 of FIG. 8, in the speaker device according to the comparative example, the high-frequency-band limit frequency Fh is about 7.5 KHz, and the sound pressure level of the high-frequency-band limit frequency Fh is about 37 (dB).

Now, the acoustic characteristic of the speaker device 200 according to the second embodiment and the acoustic characteristic of the speaker device according to the comparative example are compared.

As described above, the high-frequency-band limit frequency Fh of the speaker device 200 according to the second embodiment is about 4 KHz, and the high-frequency-band limit frequency Fh of the speaker device according to the comparative example is about 7.5 KHz. Thus, the high-frequency-band limit frequency Fh of the speaker device 200 according to the second embodiment is smaller than that of the comparative example. In addition, in the second embodiment and the comparative example, the peak being the unnecessary high-frequency component occurs around the high-frequency-band limit frequency Fh, respectively, as shown in the broken line area E5 in FIG. 7 and the broken line area E6 in FIG. 8. As understood by comparing the sizes of the peaks, in the speaker device 200 according to the second embodiment, the peak being the unnecessary high-frequency component is smaller than that of the comparative example. The reason will be explained. Specifically, the high-frequency-band limit frequency Fh in the speaker device is expressed by an equation below.
Fh=½π√{(1/m1)+(1/m2)}×Sn (1)
In this equation, “m1”, “m2” and “Sn” show mass (Kg) of the voice coil 4, mass (Kg) of the diaphragm and stiffness (N/m) of the inner peripheral portion (neck) of the diaphragm, respectively.

In the second embodiment, the step portion 5a is provided at the inner peripheral portion (neck) of the diaphragm 5. Particularly, the upper surface 5ab of the step portion 5a has the flatness in the direction perpendicular to the vibrating direction of the diaphragm 5, as described above. Thus, at the time of vibrating of the diaphragm 5, at the step portion 5a, the strength in the vibrating direction (the directions of the arrows Y2 and Y3 shown in FIG. 6) decreases, and the stiffness Sn in the above-mentioned equation (1) becomes small. Thereby, there is such an advantage that the high-frequency-band limit frequency Fh in the above-mentioned equation (1) can decrease and hence the occurrence of the unnecessary high frequency-component (peak) thereabout can be suppressed (high-cut corrugation operation). On the other hand, in the speaker device according to the comparative example, since the diaphragm having the straight cross-section is used, the peak easily occurs around the high-frequency-band limit frequency Fh.

When the graph W2 of the secondary harmonic distortion of the second embodiment and the graph W12 of the secondary harmonic distortion of the comparative example are compared, the secondary harmonic distortion of the second embodiment is smaller than that of the comparative example in the frequency band larger than about 100 Hz. In addition, the relation between the tertiary harmonic distortion of the second embodiment and the tertiary harmonic distortion of the comparative example is the same. Namely, when the graph W3 of the tertiary harmonic distortion of the second embodiment and the graph W13 of the tertiary harmonic distortion of the comparative example are compared, the tertiary harmonic distortion of the second embodiment is smaller than that of the comparative example in the frequency band larger than about 100 Hz. This is because the 2-magnetic gaps and 2-voice coils system is employed in the magnetic circuit system 30. Namely, in the magnetic circuit system 30, since the winding direction of the first voice coil 4a around the voice coil bobbin 2 is opposite to the winding direction of the second voice coil 4b around the voice coil bobbin 2, at the time of the driving of the speaker device 200, the self-inductance of the first voice coil 4a and the self-inductance of the second voice coil 4b are set off (canceled).

(Modification)

In the above first and second embodiments, the winding direction of the first voice coil 4a around the voice coil bobbin 2 is opposite to the winding direction of the second voice coil 4b around the voice coil bobbin 2, and the electric signal having the same level and phase is inputted to each of them, respectively. However, this invention is not limited to it. Namely, in this invention, the winding direction of the first voice coil 4a around the voice coil bobbin 2 may be the same as the winding direction of the second voice coil 4b around the voice coil bobbin 2, and the electric signal having the same level and the opposite phase may be inputted to each of them. In this case, the operation and effect of the present invention can be obtained, too.

### Third Embodiment

This embodiment is related to a mounting method of the speaker device. In summary, in this embodiment, in view of the whole weight balance of the speaker device, the magnetic circuit system having the large weight compared with other components of the speaker device is arranged on the front side (sound output side) of the diaphragm, and the gravity of the speaker device is set to the sound output side (front side) of the diaphragm. Then, at the mounting portion of the frame positioned on the plan surface including the gravity, the speaker device is mounted on the mounted portion. Thereby, the distance (projecting dimension) that the component of the speaker device projects on the sound output side of the diaphragm with respect to the speaker mounting portion becomes as small as possible. Moreover, at the time of the driving of the speaker device, it is suppressed that the unnecessary vibration is transmitted to the speaker mounting portion, and it is prevented that the abnormal sound is emitted from the speaker mounting portion.

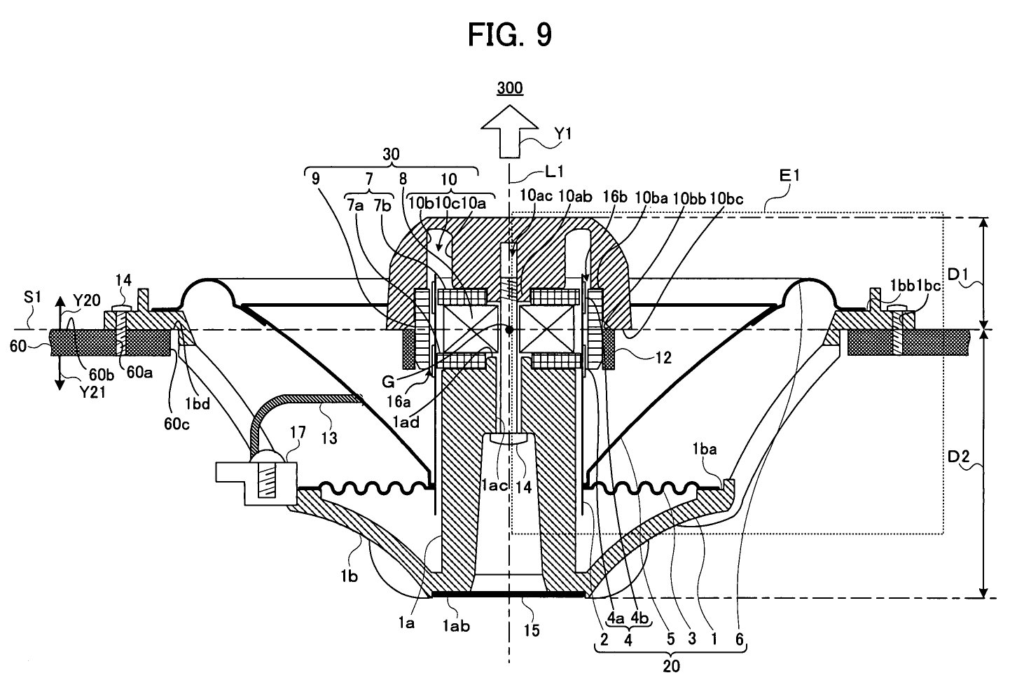

Next, the description will be given of the mounting method of a speaker device 300 having the above-mentioned configuration. FIG. 9 shows the configuration of the speaker device 300 according to this embodiment. The speaker device 300 according to this embodiment basically has the same configuration as the speaker devices according to the first and second embodiments. However, in the speaker device 300 according to this embodiment, a screw hole 1bc into which the bolt 14 is inserted is formed on the second flat portion 1bb. In the speaker device 300, the magnetic circuit system 30 having the large weight compared with other components of the speaker device is arranged on the front side (sound output side) of the diaphragm 5. Therefore, gravity G of the speaker device 300 is positioned on the front side (sound output side).

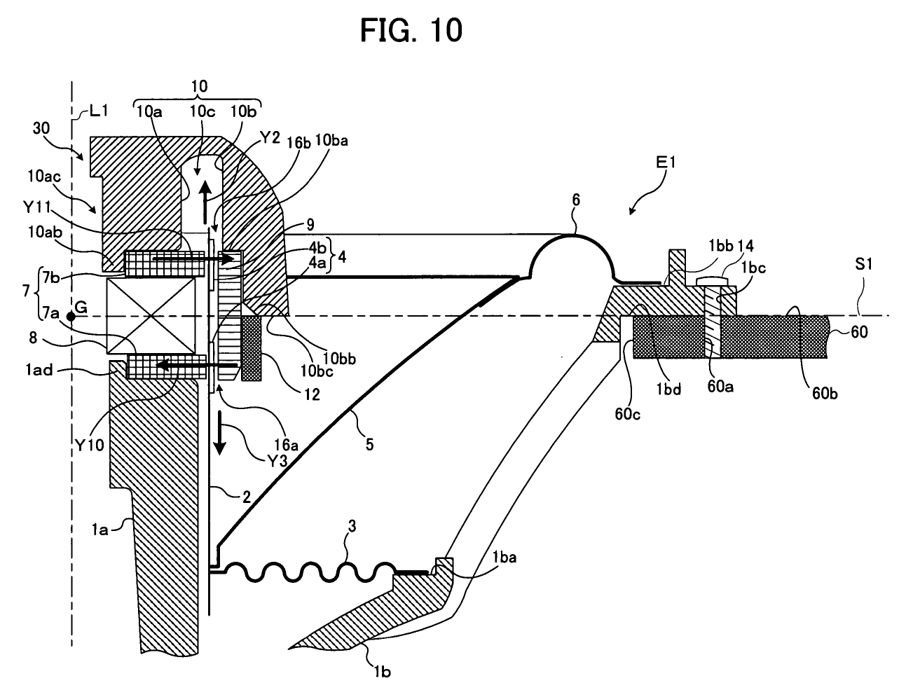

In addition, the speaker device 300 has a mounting portion mounted onto a mounting base 60 via the frame 1. The mounting portion is provided at a position corresponding to the gravity G of the speaker device 300. The mounting portion corresponds to the lower surface 1bd of the second flat portion 1bb of the frame 1. Namely, the lower surface 1bd of the second flat portion 1bb of the frame 1 is the mounting portion mounted onto the mounting base 60. In addition, the lower surface 1bd (mounting portion) of the frame 1 is positioned on a plan surface S1 having the gravity G of the speaker device 300 and substantially perpendicular to the vibrating direction (the directions of the arrows Y2 and Y3 shown in FIG. 10) of the diaphragm 5. In addition, the lower surface 1bd (mounting portion) of the frame 1 is positioned on the plan surface S1 including the substantial center in the direction of the thickness of the magnet 8. Further, a height D2 from the lower surface of the pole portion 1a (projecting portion) of the frame 1 to an upper surface 60b of the mounting base 60 is the same as the height from the lower surface of the pole portion 1a (projecting portion) of the frame 1 to the gravity G. The lower surface 1bd (mounting portion) of the frame 1 positioned at such a position is mounted onto the upper surface 60b of the mounting base 60 via the fixing member such as the bolt 14. Thereby, the speaker device 300 is fixed to the mounting base 60. The mounting base 60 is a component constituting the vehicle, such as a door and inner panel for the vehicle, for example. As shown in FIG. 9, an opening, i.e., a mounting hole 60c, is formed onto the mounting base 60. Additionally, in shown in FIG. 9, the directions of an arrow Y20 and an arrow Y21 with respect to the mounting base 60 show a seat side of the vehicle and inner sides of the door and the inner panel, respectively.

The mounting method of the speaker device 300 according to this embodiment is as follows.

First, the magnetic circuit system 30 is inserted into the mounting hole 60c of the mounting base 60 from the direction opposite to the arrow Y1, and the positions of the screw hole 1bc of the second flat portion 1bb and a screw hole 60a of the mounting base 60 are adjusted. Then, the lower surface (mounting portion) 1bd of the second flat portion 1bb of the frame 1 contacts an upper surface 60ab of the mounting base 60. Next, the bolt 14 is screwed into the screw hole 1bc of the second flat portion 1bb and the screw hole 60a of the mounting base 60 from the direction opposite to the arrow Y1, and the second flat portion 1bb and the mounting base 60 are screwed together by the bolt 14. Thereby, the speaker device 300 is fixed onto the mounting base 60 in such a manner that the lower surface (mounting portion) 1bb of the frame 1 positioned on the plan surface S1 including the gravity G contacts the upper surface 60b of the mounting base 60. At this time, the plan surface S1 including the gravity G of the speaker device 300 is substantially positioned on the same surface as the upper surface 60b of the mounting base 60.

As described above, in this embodiment, the magnetic circuit system 30 having the large weight compared with other components of the speaker device 300 is arranged on the sound output side (front side) of the diaphragm 5, and the gravity G of the speaker device 300 is set on the front side (sound output side). Moreover, the mounting portion (the lower surface 1bd of the frame 1) mounted onto the mounting base 60 is provided at the position corresponding to the gravity G of the speaker device 300.

Thereby, the distance that the component of the speaker device 300 projects on the sound output side of the diaphragm 5 with respect to the upper surface 60b of the mounting base 60, i.e., the distance D1 (projecting dimension D1) from the upper surface 60b of the mounting base 60 to the upper surface of the magnetic circuit holder 10, can be as small as possible. Therefore, when the speaker device 300 is mounted onto the door and the inner panel of the vehicle for example, the dimension that the components of the speaker device project from the door and the surface of the inner panel to the seat side of the vehicle can be as small as possible. Hence, the speaker device 300 of this embodiment can be easily mounted onto various positions of the vehicle.

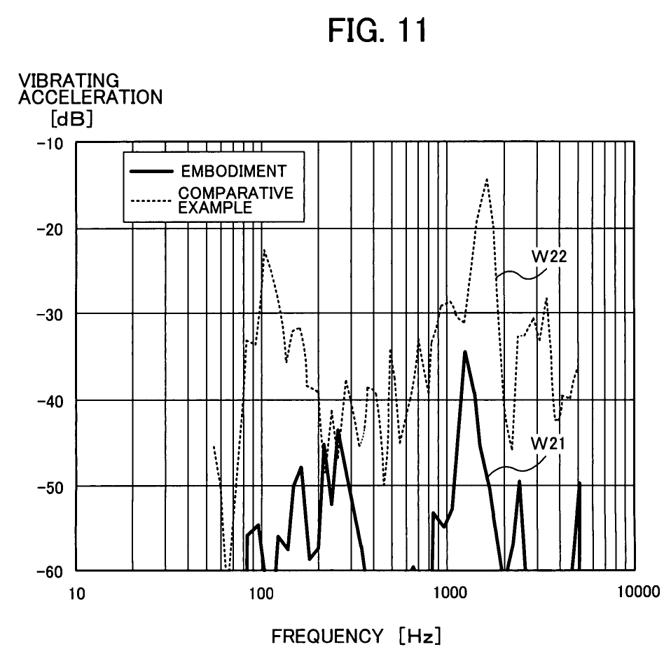

In addition, as described above, since the lower surface (mounting portion) 1bd of the frame 1 positioned on the plan surface S1 including the gravity G of the speaker device 300 is mounted onto the upper surface 60b of the mounting base 60, at the time of the driving of the speaker device 300, it can be suppressed that the vibration due to the diaphragm 5 is transmitted to the side of the mounting base 60 via the frame 1, and the occurrence of the abnormal sound from the mounting base 60 can be prevented. This point will be explained with reference to FIG. 11.

In FIG. 11, the vertical axis indicates vibrating acceleration of a measuring device, and the horizontal axis indicates the frequency of the speaker device 300, respectively. At the time of the measurement, an acceleration pickup is used as the measuring device, and a portion (a direction vertical to the vibrating direction of the diaphragm 5) of the magnetic circuit system 30 of the speaker device 300 is set as the measurement point. Since the speaker device 300 is mounted onto the mounting base 60 via the bolt 14, the speaker device 300 and the mounting base 60 move as one rigid body. A graph W21 is a graph that the speaker device 300 is mounted onto the door and inner panel of the vehicle serving as the mounting base 60 and the transmission state of the vibration to the door and the inner panel is measured. A graph W22 is a graph that the speaker device according to the comparative example is mounted onto the door and inner panel of the vehicle similarly to the case of the graph W21 and the transmission state of the vibration to the door and the inner panel is measured. The illustration of the speaker device according to the comparative example is omitted, but the configuration thereof will be explained. Namely, the speaker device according to the comparative example is basically similar to the speaker device 300 shown in FIG. 9, but the magnetic circuit 30 is arranged on the rear side (side opposite to the sound output side) of the diaphragm 5, and the gravity G of the speaker device is not positioned at the mounting position of the mounting base 60.

As shown in FIG. 11, in the speaker device 300 according to this embodiment, the vibrating acceleration of the acceleration pickup in the wide frequency band is smaller than that of the comparative example. Namely, in the speaker device 300 of this embodiment, it can be suppressed that the vibration occurring from the diaphragm 5 is transmitted to the door and the inner panel in the wide frequency band.

(Modification)

In the above-mentioned embodiment, the winding direction of the first voice coil 4a around the voice coil bobbin 2 is opposite to the winding direction of the second voice coil 4b around the voice coil bobbin 2, and the electric signal having the same level and phase is inputted to each of them, respectively. However, this invention is not limited to this. Namely, in this invention, when the first voice coil 4a and the second voice coil 4b are independently formed, the winding direction of the first voice coil 4a around the voice coil bobbin 2 may be the same as the winding direction of the second voice coil 4b around the voice coil bobbin 2, and the electric signal having the same level and the opposite phase may be inputted to each of them, respectively.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Applications No. 2004-334526 filed on Nov. 18, 2004, No. 2004-337402 filed on Nov. 22, 2004 and No. 2004-337406 filed on Nov. 22, 2004 including the specifications, claims, drawings and summaries are incorporated herein by reference in their entirety.

What is claimed is:

1. A voice coil device comprising:
a voice coil bobbin;
a voice coil which has a lead wire and is wound around the voice coil bobbin; and
a wound member which is divided into at least two parts and is attached to the voice coil bobbin to cover a part of the lead wire,
wherein the lead wire is gently curved and bent into a curve shape between the voice coil bobbin and the wound member to be drawn out from a border of the divided wound member.

2. The voice coil device according to claim 1, wherein a bent portion of the lead wire has an acute angle.

3. The voice coil device according to claim 1, wherein the wound member has a first wound member and a second wound member, a part of the lead wire is covered with the first wound member, and a bent portion of the lead wire is covered with the second wound member.

4. The voice coil device according to claim 1, wherein the lead wire is bent in a direction from the second wound member to the first wound member between the voice coil bobbin and the second wound member to be drawn out in an outer circumferential direction of the first wound member.

5. The voice coil device according to claim 1, wherein the wound member fixes the lead wire to the voice coil bobbin.

6. A speaker device comprising:
a magnetic circuit; and
a vibration system including a diaphragm and a voice coil device having: a voice coil bobbin; a voice coil having a lead wire and wound around the voice coil bobbin; and a wound member divided into at least two parts and attached to the voice coil bobbin to cover a part of the lead wire,
wherein the lead wire is gently curved and bent into a curve shape between the voice coil bobbin and the wound member to be drawn out from a border of the divided wound member,
wherein the magnetic circuit is arranged on a sound output side of the diaphragm.

7. The speaker device according to claim 6, further comprising:
a tinsel cord which is electrically connected to a signal supplying circuit of an amplifier,
wherein one end of the tinsel cord is drawn on the sound output side of the diaphragm, and the lead wire drawn out of the wound member is electrically connected to the one side of the tinsel cord.

8. A speaker device comprising:
a vibration system including a diaphragm; and a magnetic circuit,
wherein the magnetic circuit is arranged on a sound output side of the diaphragm,
wherein the magnetic circuit includes plural magnetic gaps, and the vibration system includes a voice coil bobbin and plural voice coils wound around the voice coil bobbin, and
wherein each of the correspondent voice coils is arranged in each of the magnetic gaps, respectively.

9. The speaker device according to claim 8,
wherein the vibration system includes a frame having a projecting portion projecting on the sound output side of the diaphragm, and
wherein the magnetic circuit is arranged on the projecting portion and is housed in a space formed on the sound output side of the diaphragm.

10. The speaker device according to claim 9,
wherein the magnetic circuit includes: a first plate; a magnet arranged on the first plate, both surfaces of which are magnetized; a second plate arranged on the magnet; and a yoke opposite to each outer peripheral wall of the first plate, the magnet and the second plate with a constant space,
wherein the plural magnetic gaps includes a first magnetic gap and a second magnetic gap,
wherein the first magnetic gap is positioned between the first plate and the yoke and the second magnetic gap is positioned between the second plate and the yoke,
wherein the plural voice coils includes a first voice coil and a second voice coil, and
wherein the first voice coil is arranged in the first magnetic gap and the second voice coil is arranged in the second magnetic gap.

11. The speaker device according to claim 9,
wherein the vibration system includes a supporting member arranged on the second plate and supporting the yoke, and
wherein the supporting member has a space in which the voice coil bobbin can move in a moving direction of the voice coil bobbin.

12. The speaker device according to the claim 10, further comprising:
a signal supplying circuit which supplies an electric signal having same level and phase to the first voice coil and the second voice coil,
wherein the first voice coil and the second voice coil have a same effective line length and are relatively wound in opposite directions.

13. The speaker device according to claim 10, further comprising:
a signal supplying circuit which supplies an electric signal having a same level and an opposite phase to the first voice coil and the second voice coil,
wherein the first voice coil and the second voice coil have a same effective line length and are relatively wound in a same direction.

14. The speaker device according to claim 8, wherein the magnetic circuit includes a yoke, and wherein a buffer member having a buffer function is provided on an outer peripheral wall of the yoke.

15. The speaker device according to claim 8, wherein a step portion having a flat surface in a direction perpendicular to a moving direction of the diaphragm is provided in an inner peripheral portion of the diaphragm.

16. The speaker device according to claim 15,
wherein a buffer member having a buffer function and formed into an annular shape is provided on the flat surface.

17. A speaker device comprising:
a vibration system including a diaphragm;
a magnetic circuit arranged on a sound output side of the diaphragm; and
a mounting portion to be mounted on a mounting base,
wherein the mounting portion is provided at a position corresponding to gravity of the speaker device.

18. The speaker device according to claim 17, wherein the mounting portion is positioned on a plan surface including gravity of the speaker device and on a plan surface substantially perpendicular to a vibrating direction of the diaphragm.

19. The speaker device according to claim 17,
wherein the vibration system includes a frame having a projecting portion projecting on the sound output side of the diaphragm and a flange portion formed into a substantial cup shape and extending outward from a lower end portion of the projecting portion,
wherein the flange portion has a first flat portion supporting an outer peripheral edge portion of a damper at a substantially middle portion and a second flat portion supporting an outer peripheral edge portion of an edge at an upper end portion thereof, and
wherein the mounting portion is a lower surface of the second flat portion.

20. The speaker device according to claim 19, wherein a height from the lower surface of the projecting portion to the mounting portion is same as a height from the lower surface of the projecting portion to the gravity.

21. The speaker device according to claim 19,
wherein the magnetic circuit includes a first plate; a magnet arranged on the first plate; a second plate arranged on the magnet; and a yoke opposite to each outer peripheral wall of the first plate, the magnet and the second plate with a constant space,
wherein the magnetic circuit is arranged on the projecting portion, and
wherein the mounting portion is positioned on a plan surface including a substantial center in a thickness direction of the magnet.

22. The speaker device according to claim 17,
wherein the mounting base is a component of a vehicle, and
wherein the mounting portion is mounted onto the mounting base via a fixing member.
